(19) United States
(12) Patent Application Publication
(10) Pub. No.: US 2006/0146128 A1
(43) Pub. Date: Jul. 6, 2006

(54) Method of driving display device and display device for performing the same

(75) Inventors: Won-Seok Ma, Seongnam-si (KR); Jong-Whan Cho, Gunpo-si (KR)

Correspondence Address: David W. Heid;MacPHERSON KWOK CHEN & HEID LLP, Suite 226, 1762 Technology Drive, San Jose, CA, 95110, US

(73) Assignee: Samsung Electronics Co., Ltd.

(21) Appl. No.: 11/321,849

(22) Filed: Dec. 28, 2005

(30) Foreign Application Priority Data
Jan. 6, 2005 (KR) 2005-1228

(51) Int. Cl. H04N 7/18

(52) U.S. Cl. 348/89

(57) ABSTRACT

A display device may include a driver with a plurality of N digital to analog converters in communication with a plurality of M data lines, where M is greater than N. A digital to analog converter may be in communication with P data lines, which may receive a first sequence of P data signals and subsequently receive a second different sequence of P data signals. A display device has a plurality of scan lines, a plurality of data lines and switching elements electrically coupled to the scan lines and the data lines. Scan signals are sequentially outputted to the scan lines. Image signals that are different from one another are applied to the data lines grouped by a predetermined number. Adjacent image signals of the image signals applied to adjacent data lines of the data lines have different transmission sequences during at least one frame. Therefore, an image display quality of the display device is improved.

### CROSS-REFERENCE TO RELATED APPLICATION

This application claims priority to Korean Patent Application No. 2005-01228 filed on Jan. 6, 2005, the contents of which are herein incorporated by reference in their entirety.

### BACKGROUND OF THE INVENTION

1. Field of the Invention

The present invention relates to a method of driving a display device and a display device for performing the method. More particularly, the present invention relates to a method of driving a display device that be performed using a driver unit having a reduced chip area, and a display device for performing the method.

2. Description of the Related Art

Generally, a liquid crystal display (LCD) device displays image data using a liquid crystal material. The display device applies an electric field to a specific molecular arrangement of the liquid crystal to convert the specific molecular arrangement into another molecular arrangement.

LCD devices may be classified as one of two general types of displays, which use different driving methods: an active matrix display using switching elements and a twisted nematic (TN) liquid crystal, and a passive matrix display using a super twisted nematic (STN) liquid crystal.

The active matrix display is used in a thin film transistor (TFT) LCD device, and the associated LCD device driving method uses TFTs as switching elements.

In contrast, the passive matrix display does not use transistors as the switching elements. The passive matrix display has a simpler circuit than the active matrix display.

Different types of TFT LCDs may be used for display devices. For example, one type of TFT LCD is an amorphous silicon (a-Si) TFT LCD, while another is a poly silicon (poly-Si) TFT LCD. The poly-Si TFT LCD generally has lower power consumption and lower manufacturing cost than the a-Si TFT LCD. However, the manufacturing process for the poly-Si TFT LCD is more complex than the manufacturing process for the a-Si TFT LCD. Additionally, the a-Si TFT LCD has a smaller chip area and has a higher yield than the poly-Si TFT LCD.

FIG. 1 is a plan view illustrating a TFT substrate of a conventional poly-Si TFT LCD, and FIG. 2 is a plan view illustrating a TFT substrate of a conventional a-Si TFT LCD.

As shown in FIG. 1, the poly-Si TFT LCD includes a data driver 12 on a glass substrate 10 and a gate driver 14 on the glass substrate 10. A pixel array 15 is formed on substrate 10. The poly-Si TFT LCD device further includes a terminal unit 16 and an integrated printed circuit board (PCB) 20. The terminal unit 16 is electrically coupled to the integrated PCB 20 through a film cable 18. Electrically connecting the terminal unit 16 to the integrated PCB 20 simplifies the structure of the poly-Si TFT LCD, and reduces the manufacturing cost.

As shown in FIG. 2, the a-Si TFT LCD includes a data driver chip 34 formed on a data flexible circuit board (FCB) 32 using the chip on film (COF) method. Data PCB 36 is electrically coupled to data line terminals of the pixel array 35 formed on a substrate 30 through the data FCB 32. Similarly, the a-Si TFT LCD includes a gate driver chip 40 formed on a gate FCB 38 using the COF method. A gate printed circuit board 42 is electrically coupled to gate line terminals of the pixel array 35 through the gate FCB 38.

Recently, the a-Si TFT LCD device includes an integrated PCB, and the gate power supply unit is mounted on a data PCB so that the gate PCB is omitted. That is, in order to simplify a structure of a-Si TFT LCD device, the data driver, a DC/DC converter and the gate driver are integrated into one driver chip.

The gate driver provides power-enabling signals and power-disabling signals to the gate lines to turn the transistors on and off in sequence. Therefore, the gate driver circuitry in the integrated driver chip has a relatively simple circuit structure. The gate driver in the integrated driver chip thus has a smaller size.

However, the data driver converts digital-type image data that is from an external device into analog-type image data based on the control signals, and the analog-type image data is applied to the liquid crystal display panel. The data driver in the integrated driver chip thus has a more complex circuit structure than the gate driver. Therefore, the data driver occupies a relatively large space in the integrated driver chip.

Particularly, a digital/analog converter (DAC) of the data driver and an output unit occupy a large space on the integrated driver chip. The output unit includes amplifiers that are electrically coupled to the DAC, and amplify the converted analog-type image data to generate an amplified image signal.

FIG. 3 is a block diagram illustrating a digital/analog converter unit and an output unit of a conventional data driver.

Referring to FIG. 3, a digital/analog converter 50 of a conventional data driver includes a plurality of digital-to-analog converters DACs. Each output of the DACs of the digital/analog converter 50 is electrically coupled to each of the output buffers of an output unit 60. That is, the analog image signal output from a first digital-to-analog converter DAC1 is amplified by a first output buffer AMP1 of the output unit 60, and the amplified image signal is applied to the liquid crystal display panel. Similarly, the analog image signal output from a second digital-to-analog converter DAC2 is amplified by a second output buffer AMP2 of the output unit 60, and the amplified image signal is applied to the liquid crystal display panel. Finally, the analog image signal output from an n-th digital-to-analog converter DACn is amplified by an n-th output buffer AMPn of the output unit 60, and the amplified image signal is applied to the liquid crystal display panel.

Each of the DACs includes resistor elements. For a one bit increase in digital image data size, the number of resistor elements per DAC is doubled. Large numbers of resistor elements per DAC may greatly increase the required space for the DACs on the integrated driver chip. In addition, large numbers of resistor elements may significantly increase the power consumption of the data driver.

### SUMMARY OF THE INVENTION

Embodiments of the present invention provide a method of driving a liquid crystal display device that may be used with a data driver having a reduced size. The systems and techniques may also provide for reduced power consumption and improved image display quality.

Embodiments of the present invention also provide a display device for performing the method of driving the liquid crystal display device.

In general, in one aspect, a method of driving a display comprises sequentially outputting scan signals to a plurality of scan lines. The method may further comprise outputting a first group of N image signals in a first sequence to N grouped data lines of a plurality of data lines. The method may further comprise subsequently outputting a second group of N image signals in a second different sequence to the N grouped data lines. N may be three, and may correspond to three different image color signals, such as red, blue, and green image color signals. The first sequence and the second sequence may be output during one frame, or may be output during a frame group. The frame group may comprise N frames, and N different sequences may be output during the frame group.

In general, in another aspect, a display device may comprise a data driver configured to apply a first group of a pre-determined number N of image signals in a first sequence to N grouped data lines of a plurality of data lines, and configured to subsequently apply a second group of N image signals in a second different sequence to the N grouped data lines.

In general, in another aspect, a method of driving a display device is provided as follows. The display device includes a plurality of scan lines, a plurality of data lines and switching elements electrically coupled to the scan lines and the data lines. Scan signals are sequentially outputted to the scan lines. Image signals that are different from one another are outputted to the data lines grouped by a predetermined number. Adjacent image signals of the image signals applied to adjacent data lines of the data lines have different transmission sequences during at least one frame. In some embodiments, the number of the data lines in one group is three.

The adjacent image signals of the image signals are applied to the adjacent data lines of the data lines having different transmission sequences during one frame. The image signals include red image data, green image data and blue image data.

A time period for activating each of the scan lines is divided so that the image signals are applied to the data lines during each of the divided time periods, respectively.

The image signal may include red image data, green image data and blue image data. The image signals having the red, green and blue image data are applied to the data lines during each of the divided time periods, respectively, and the adjacent image signals of the image signals applied to the adjacent data lines of the data lines are different from each other. In some embodiments, the image signals applied to the data lines during subsequent divided time periods are different from each other.

Accordingly, image signals of the analog type are applied to one unit cell. A time period corresponding to each of the scan lines is divided into a plurality of time period portions through a time division operation, and different image signals are applied to the data lines during each of the frames. Therefore, the charging time and the discharging time of the liquid crystal capacitors are substantially the same, thereby improving an image display quality of the display device.

In another aspect of the present invention, a display device includes a display panel, a scan driver and a data driver. The display panel includes a plurality of scan lines, a plurality of data lines and a plurality of switching elements electrically coupled to the scan lines and the data lines. The scan driver is configured to sequentially output a plurality of scan signals to the scan lines. The data driver is configured to apply image signals that are different from one another to the data lines grouped by a predetermined number, and adjacent image signals of the image signals applied to adjacent data lines of the data lines have different transmission sequences during at least one frame.

The scan driver is formed on the display panel.

In some embodiments, the data driver includes a digital/analog converter unit configured to convert image data of digital-type into the image signals of analog-type, and a signal select unit configured to selectively output the image signals to the data lines.

In some embodiments, the data driver includes a common input line configured to receive the image data and a common output line configured to output the image signals.

In some embodiments, the data driver further includes a timing controller configured to generate the select signal and selectively apply the select signal to the signal select unit.

In some embodiments, the signal select unit includes a plurality of switches coupled in parallel to the common output line, and at least one of the switches includes a metal oxide semiconductor transistor.

According to embodiments of the present invention, an area for the digital/analog converter of the data driver is decreased so that a size of the data driver is decreased, and the LCD device may have the integrated driving chip. In addition, a power consumption of the LCD device is decreased.

In general, in another aspect, a display device may include a plurality N of digital to analog converters. The device may further include a plurality M data signal lines, where each of the M data signal lines may be configured to transmit an analog signal to an associated region of the display to generate an image portion, and where N is less than M. Each of the N digital to analog converters may be in communication with a plurality P of the M data signal lines, where P is less than M. In some embodiments P is three, corresponding to red, blue, and green signals.

The device may further comprise an associated signal selector in communication with each of the N digital to analog converters. The associated signal selector for a first digital to analog converter may be configured to transmit a first sequence of P analog signals generated by the first digital to analog converter to the P associated data lines, and to subsequently transmit a second different sequence of P analog signals generated by the first digital to analog converter to the P associated data lines. The device may further comprise a timing controller configured to control at least one of the associated signal selectors.

### BRIEF DESCRIPTION OF THE DRAWINGS

The above and other advantages of the present invention will become readily apparent by reference to the following detailed description when considered in conjunction with the accompanying drawings wherein:

FIG. 1 is a plan view illustrating a TFT substrate of a conventional poly-Si TFT LCD;

FIG. 2 is a plan view illustrating a TFT substrate of a conventional a-Si TFT LCD;

FIG. 3 is a block diagram illustrating a digital/analog converter unit and an output unit of a conventional data driver;

FIG. 4 is a perspective view illustrating an LCD panel assembly according to an embodiment of the present invention;

FIG. 5 is a plan view illustrating an arrangement of color filters according to a comparative embodiment of the present invention;

FIG. 6 is a plan view illustrating an arrangement of color filters according to an embodiment of the present invention;

FIG. 7 is a plan view illustrating a TFT substrate of a-Si TFT-LCD according to an embodiment of the present invention;

FIG. 8 is a block diagram illustrating an integrated control/data driver chip shown in FIG. 7;

FIG. 9 is a block diagram illustrating a digital/analog converter unit shown in FIG. 8;

FIG. 10 is timing diagram illustrating a data applying method according to a comparative embodiment of the present invention;

FIG. 11 is a circuit diagram illustrating an equivalent circuit of a liquid crystal display device according to a comparative embodiment of the present invention;

FIG. 12 is timing diagram illustrating R, G and B signals outputted from an LCD device according to a comparative embodiment of the present invention;

FIG. 13 is a graph illustrating a charge/discharge amount of a liquid crystal capacitor according to a data applying method shown in FIG. 10;

FIG. 14 is timing diagram illustrating a data applying method according to an embodiment of the present invention;

FIGS. 15 through 17 are graphs illustrating a charge/discharge amount of a liquid crystal capacitor according to a data applying method shown in FIG. 10; and

FIG. 18 is a flow chart illustrating a driving method of a display device according to an embodiment of the present invention.

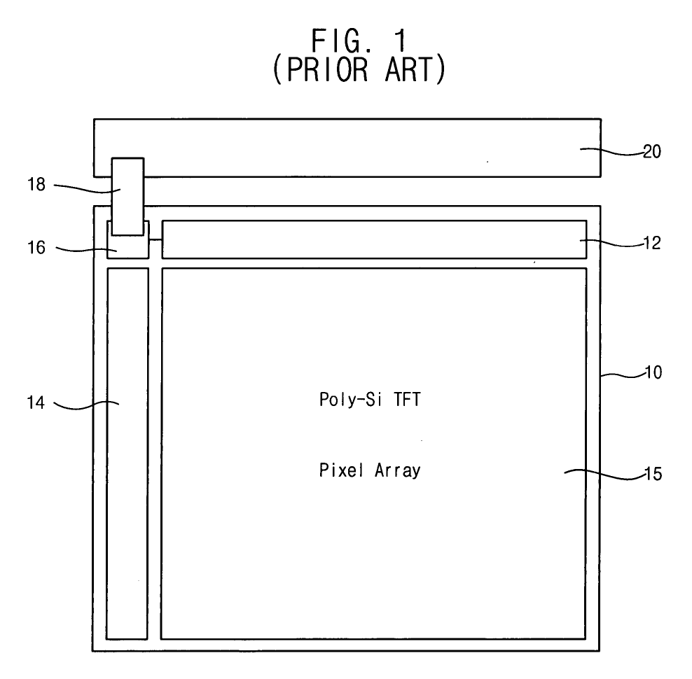

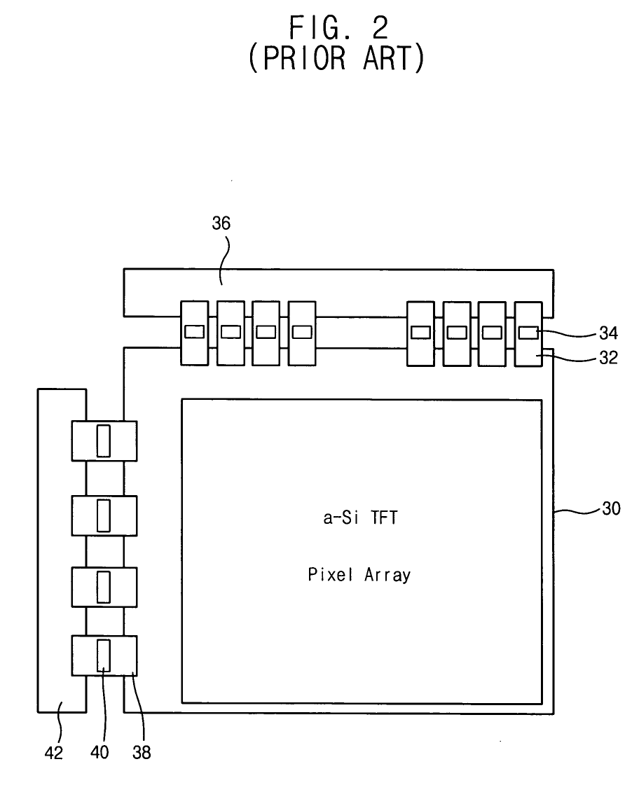

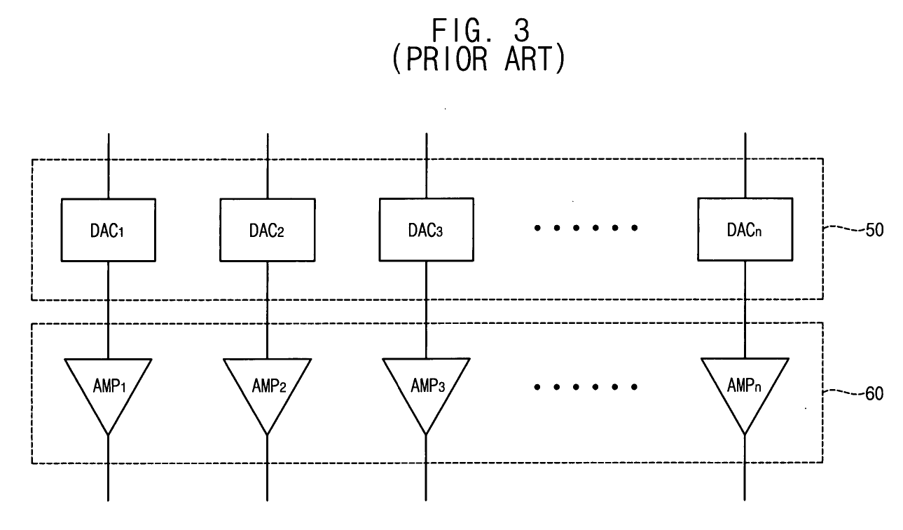

### DETAILED DESCRIPTION

The invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully describe the invention to those skilled in the art. Like reference numerals refer to like elements throughout.

It will be understood that when an element is referred to as being “on” another element, it can be directly on the other element or intervening elements may be present. In contrast, when an element is referred to as being “directly on” another element, there are no intervening elements present. As used herein, the term “and/or” includes any and all combinations of one or more of the associated listed items.

It will be understood that, although the terms first, second, etc. may be used herein to describe various elements, these elements should not be limited by these terms. These terms are only used to distinguish one element from another. For example, a first thin film could be termed a second thin film, and, similarly, a second thin film could be termed a first thin film without departing from the teachings of the disclosure. Additionally, reference to an element as “first” does not imply that two or more elements are needed.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another elements as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments of the present invention are described herein with reference to schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present invention.

Hereinafter, the present invention will be explained in detail with reference to the accompanying drawings.

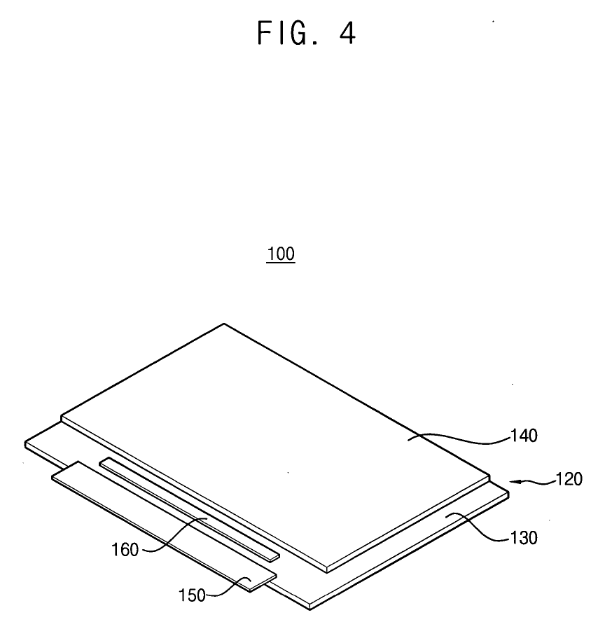

FIG. 4 is a perspective view illustrating a liquid crystal display (LCD) panel assembly according to an embodiment of the present invention.

Referring to FIG. 4, the LCD panel assembly 100 includes an LCD panel 120, a flexible circuit board 150 and an integrated control/data driver chip 160.

The liquid crystal display panel 120 includes a thin film transistor (TFT) substrate 130 and a color filter substrate 140. The TFT substrate 130 includes a display cell array circuit and a scan driver having amorphous silicon (a-Si) TFTs. In the exemplary LCD panel assembly shown in FIG. 4, the display cell array circuit and the scan driver are formed from the same layers. The integrated control/data driver chip 160 is formed on a predetermined region of the TFT substrate 130, and receives a drive voltage and a digital-type image data from the flexible circuit board 150 to drive the LCD panel 120.

The color filter substrate 140 includes color filters and transparent common electrodes. The TFT substrate 130 and the color filter substrate 140 are disposed opposite to each other, and a liquid crystal material is interposed between the TFT substrate 130 and the color filter substrate 140, which are then sealed. The display cell array circuit includes a red (R) display unit cell, a green (G) display unit cell and a blue (B) display unit cell to display R, G and B color images. The color filter substrate 140 includes R, G and B color filters corresponding to the R, G and B display unit cells, respectively.

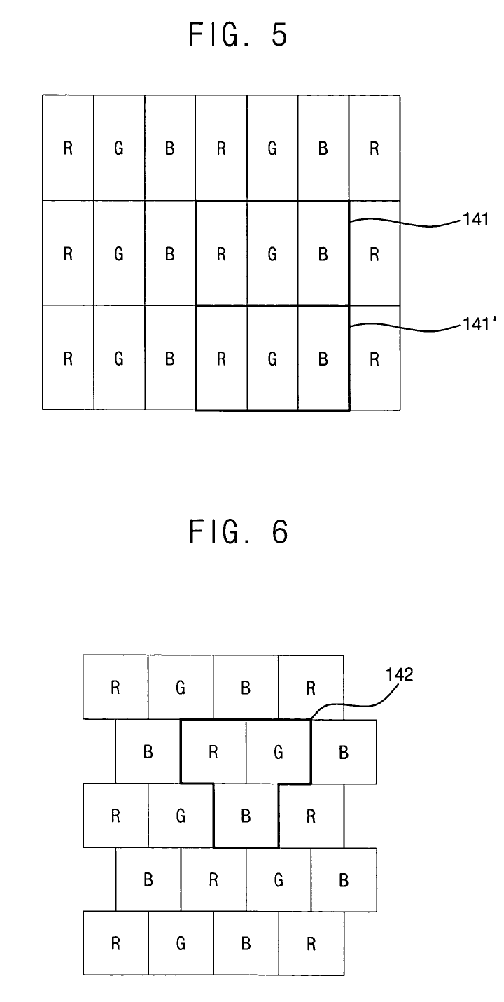

FIG. 5 is a plan view illustrating an arrangement of color filters according to a comparative embodiment of the present invention, and FIG. 6 is a plan view illustrating an arrangement of color filters according to an embodiment of the present invention.

Referring to FIG. 5, light beams that have passed through the R, G and B color filters are mixed to display a color image. That is, the three color filters corresponding to the R, G and B display unit cells form one unit pixel 141.

As illustrated in FIG. 6, adjacent unit pixels 141 have a substantially same arrangement to each other. That is, the red, green, and blue color filters of a unit pixel 141′ have the same relative positioning as the red, green, and blue color filters of unit pixel 141.

As a result, the color filters representing the same color are arranged in a stripe pattern. In the structure described above and illustrated in FIG. 5, each of the unit pixels 141 is formed corresponding to each of the unit pixels of the display cell array. Accordingly, data lines applying image signals to the unit cell and scan lines that cross the data lines are arranged in a matrix shape.

Referring to FIG. 6, three kinds of color filters form one unit pixel 142. The three color filters of the unit pixel 142 form a delta shape. A color filter substrate 130 including unit pixels having a delta structure is suitable for a display device of a digital camera. An LCD device including delta-shaped unit pixels 142 has improved mixture characteristics. In an LCD device, substantially white light (which may be generated from backlight) passes through liquid crystal cells. The liquid crystal cells have a transmittance that depends on an applied data signal. Light that is transmitted through the liquid crystal cells passes through the color filters of the unit pixel 142. Light that has been transmitted through the color filters mixes, to display the color image. Poor mixture characteristics may provide a less than satisfactory display quality.

In order to form the delta structure, the color filters of the unit pixel 142 are formed corresponding to one unit cell of the display cell array. Thus, three data lines applying an image signal to one unit cell may be formed in a generally spherical wave shape.

Referring again to FIG. 4, the flexible circuit board 150 includes a predetermined circuit pattern capable of applying digital-type image data received from an exterior source and subsequently converted to analog image data, as well as a drive voltage to switch the TFT transistors via a scan driver, to each of the units of the liquid crystal display panel 120.

The integrated control/data driver chip 160 is attached to the TFT substrate 130, and receives the digital-type image data and the drive voltage from the flexible circuit board 150. The integrated control/data driver chip 160 is electrically coupled to circuits of the TFT substrate 130 to apply a data signal, a data timing signal, a scan timing signal and a scan drive voltage to a scan driver and the display cell array of the TFT substrate 130. The scan drive voltage may be directly applied from the flexible circuit board 150 to the scan driver of the TFT substrate 130.

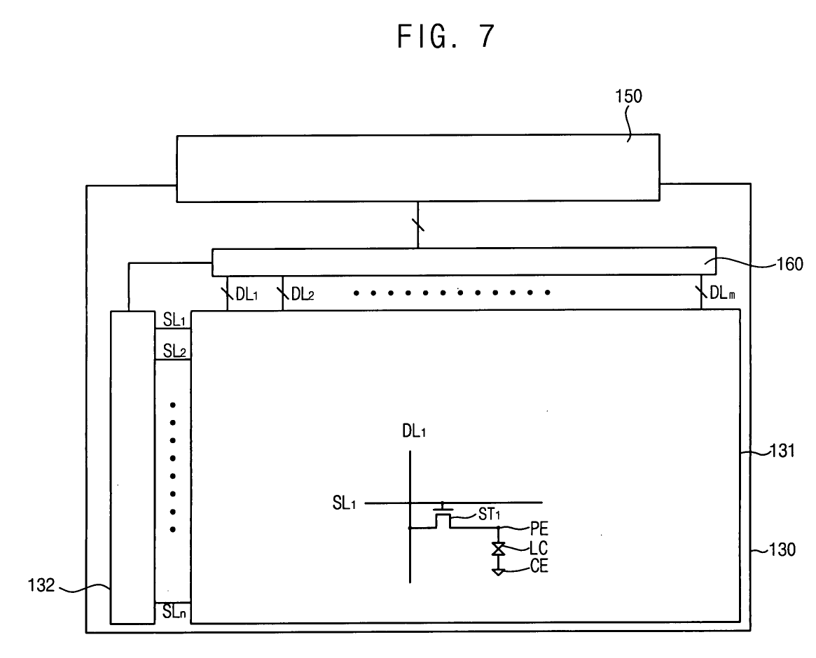

FIG. 7 is a plan view illustrating a TFT substrate of a-Si TFT-LCD according to an embodiment of the present invention.

Referring to FIG. 7, a TFT substrate 130 of a-Si TFT-LCD includes a display cell array circuit 131, a scan driver 132 and an integrated control/data driver chip 160. The scan driver 132 is formed on the TFT substrate 130.

The display cell array circuit 131 includes ‘m’ data lines DL1, DL2, . . . DLm extended in a column direction and ‘n’ scan lines SL1, SL2, . . . SLn extended in a row direction, wherein m and n denote natural numbers.

Switching transistors ST are formed at each of intersections of the data lines DL1, DL2, . . . DLm and the scan lines SL1, SL2, . . . SLn. A drain of the switching transistor ST1 is electrically coupled to the data line DL1, a gate of the switching transistor ST1 is electrically coupled to the scan line SL1, and a source of the switching transistor ST1 is electrically coupled to a transparent pixel electrode PE. The drain is a first electrode of the switching transistor ST1. The gate is a second electrode of the switching transistor ST1. The source is a third electrode of the switching transistor ST1. A channel layer of the switching transistor ST1 may be formed in a variety of ways; for example, using an amorphous silicon (a-Si) material.

A liquid crystal LC is placed between the transparent pixel electrode PE and a transparent common electrode CE formed on the color filter substrate. A gray scale of each pixel is displayed by controlling an amount of light transmitted through the associated liquid crystal LC. The transmittance is dependent on the orientation of molecules of the liquid crystal material, which is controlled by a voltage applied between the transparent pixel electrode PE and the transparent common electrode CE. When transistor ST1 is turned on by enabling scan line SL1, the data voltage on data line DL1 is applied to pixel electrode PE, to control the transmittance of the pixel to the value corresponding to the applied data voltage.

The integrated control/data driver chip 160 includes a shift register, a plurality of latches, a digital/analog converter and an output buffer, and applies analog-type image signals to the data lines DL1, DL2, . . . DLm. Additionally, the integrated control/data driver chip 160 may output a control signal for controlling the scan driver 132, and may apply a scan drive voltage to the scan driver 132.

The scan driver 132 includes a shift register, a level shifter and an output buffer, and may apply a scan drive pulse outputted from the integrated control/data driver chip 160 to the scan lines SL1, SL2, . . . SLn.

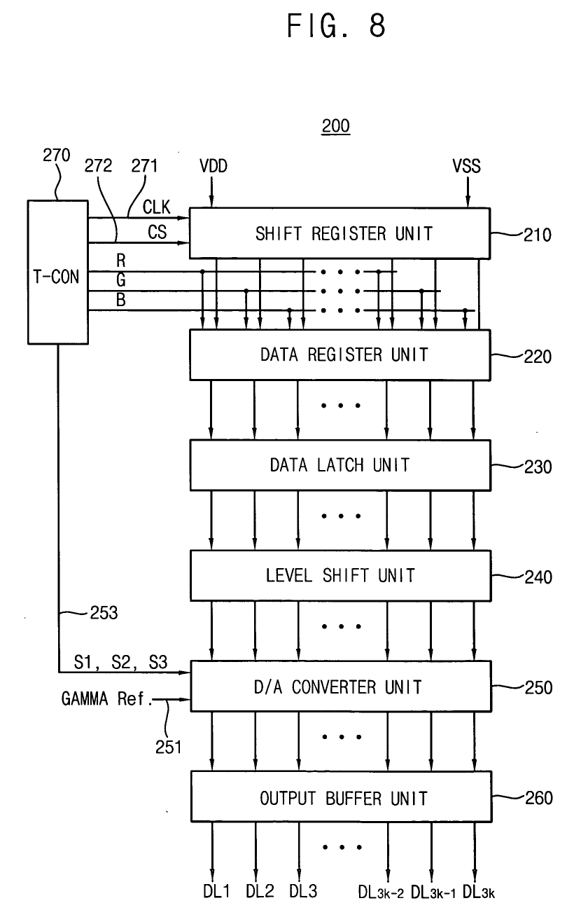

FIG. 8 is a block diagram illustrating an embodiment of an integrated control/data driver chip such as chip 160 shown in FIG. 7. In particular, the block diagram in FIG. 8 shows a data driver 200 of the integrated control/data driver chip.

Referring to FIG. 8, the data driver 200 includes a shift register unit 210, a data register unit 220, a data latch unit 230, a level shift unit 240, a digital/analog converter unit 250 and an output buffer unit 260.

In operation, the data driver 200 latches each of R, G and B data sequentially based on a dot clock CLK provided on a clock line 271 to convert the R, G and B data arranged in a dot-at-a-time-scanning manner into the R, G and B data arranged in a line-at-a-time-scanning manner, and outputs the R, G and B data to the LCD panel.

The shift register unit 210 is operated by a first power voltage VDD and a second power voltage VSS, and sequentially shifts a pulse in response to a control signal CS on a control line 272, where the control signal is provided by a timing controller 270 of the integrated control/data driver chip 200.

The data register unit 220 stores R, G and B digital type image data in response to the pulse sequentially shifted until all of the R, G and B data for one horizontal line is stored. Then, the digital type image data for the one horizontal line stored in the data register unit 220 is output to the data latch unit. The RGB data for each of the k pixels in the horizontal line is output to the data latch unit at substantially the same time.

The data latch unit 230 latches the digital type image data output from the data register unit 220 to apply the digital type image data to the level shift unit 240. The level shift unit 240 level-shifts the digital type image data output from the data latch unit 230 to a second power voltage level.

The digital/analog converter unit 250 generates an analog-type image signal in response to a gamma reference voltage GAMMA Ref. received on a line 251 to output an analog-type image signal corresponding to RGB data for each of the k pixels in the horizontal line to the output buffer unit 260. Digital/analog converter unit 250 receives data select signals S1, S2, and S3 on a line 253, as described more fully below.

The output buffer unit 260 amplifies the analog-type image signal to output an amplified analog-type image signal to the data lines DL1, DL2, DL3, . . . , DL₃ₖ₋₂, DL₃ₖ₋₁ DL₃ₖ that are electrically coupled to the integrated control/data driver chip 160.

The digital/analog converter 250 and the output buffer unit 260 are described as follows.

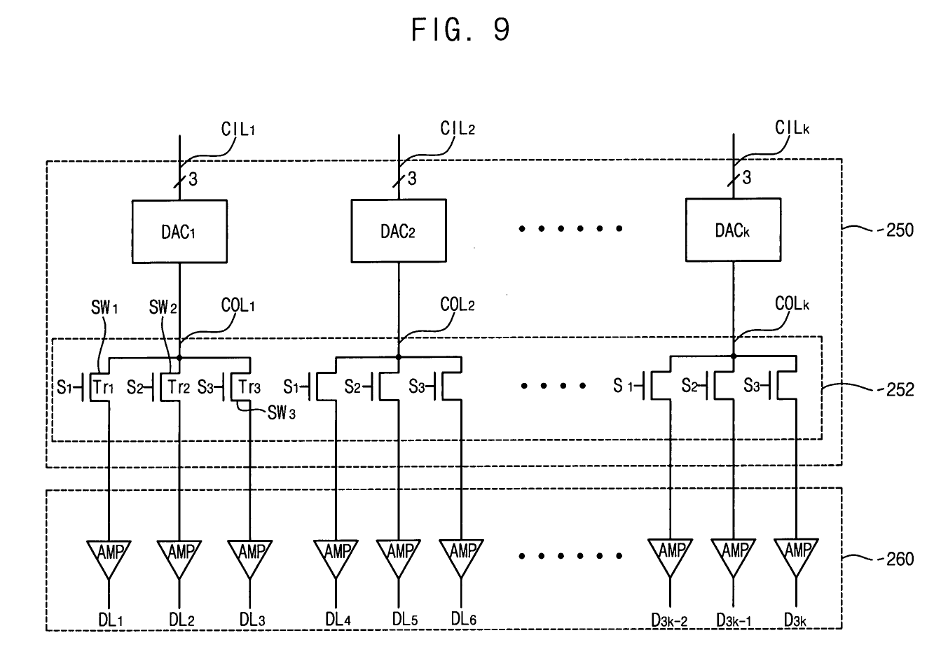

FIG. 9 is a block diagram illustrating a digital/analog converter unit shown in FIG. 8.

Referring to FIG. 9, the digital/analog converter unit 250 according to an embodiment of the present invention includes a plurality of digital/analog converters DAC1, DAC2, . . . DACk and a signal select unit 252.

Each of the digital/analog converters DAC1, DAC2, . . . DACk is electrically coupled to three data lines that are electrically coupled to one unit cell. For example, first, second and third data lines DL1, DL2 and DL3 are electrically coupled to a first common output line COL1 of a first digital/analog converter DAC1. The first digital/analog converter DAC1 is electrically coupled to a first common input line CIL1 receiving three digital-type image data signals R, G and B for one unit cell.

In addition, the first common output line COL1 is electrically coupled to the signal select unit 252 including first switch SW1, second switch SW2, and third switch SW3 used for selecting a transmission path of a converted analog-type image signal. Each of the switches of the signal selector 252 is electrically coupled to an associated one of the output buffers of the output buffer unit 260. For the example of FIG. 9, the signal selector 252 includes three switches SW1, SW2, and SW3 implemented as MOS transistors Tr1, Tr2 and Tr3 electrically coupled to the common output line COL1.

Each of the gate terminals of the MOS transistors Tr1, Tr2 and Tr3 is electrically coupled to the timing controller 270 shown in FIG. 8 and each of the MOS transistors Tr1, Tr2 and Tr3 is turned on/off in response to data select signals S1, S2 and S3 that are received from the timing controller 270 shown in FIG. 8. That is, the first digital/analog converter DAC1 receives R, B, and G signals on one or more inputs (e.g., time-multiplexed on a single input input on a common input line CIL1, or on three inputs), and outputs an associated analog R, G, or B signal for a divided portion of a time period to activate one scan line on common output line COL1. For example, DAC1 outputs each of the analog R, B, and G signals on COL1 for a time equal to about a third of the time period for one scan line. DAC1 applies the three analog-type image signals for displaying an image on one unit cell to the display cell array circuit 131 shown in FIG. 7 in response to the three data select signals S1, S2 and S3. The display cell then displays a predetermined image portion.

By using fewer DACs than the number of data lines (for example, using one third as many DACs as data lines), the size of the driver and dissipated power may be reduced accordingly. Different embodiments may be used to apply signals to the different color elements of the display device.

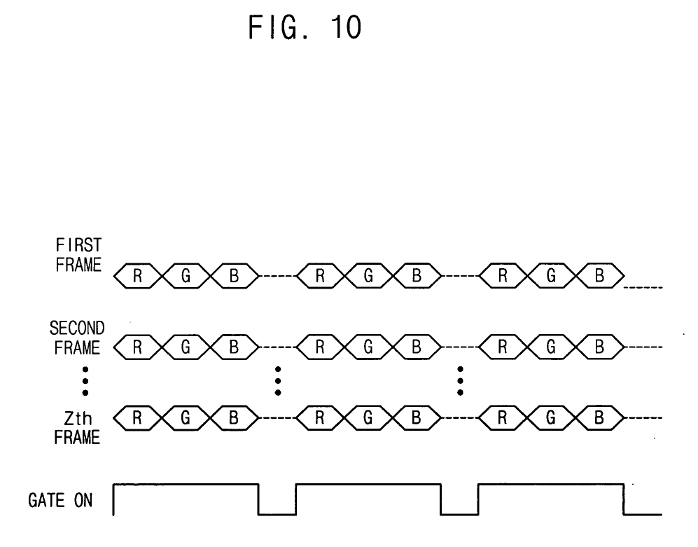

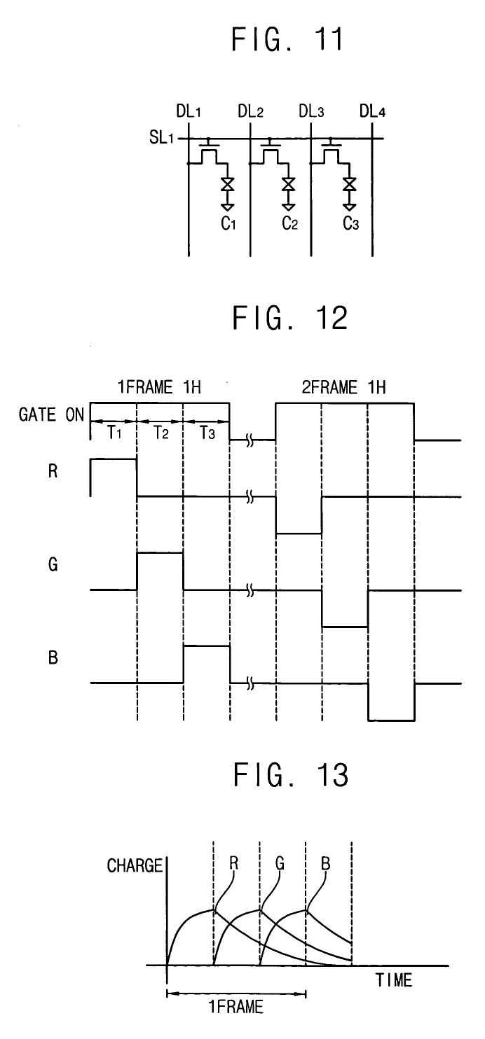

FIGS. 10 through 13 show a data applying method according to comparative embodiments of the present invention. In particular, FIG. 10 is a timing diagram illustrating a data applying method according to a comparative embodiment of the present invention. FIG. 11 is a circuit diagram illustrating an equivalent circuit of a liquid crystal display device according to a comparative embodiment of the present invention. FIG. 12 is timing diagram illustrating R, G and B signals output from an LCD device according to a comparative embodiment of the present invention. FIG. 13 is a graph illustrating liquid crystal capacitor charging and discharging, according to the data applying method shown in FIG. 10.

Referring to FIG. 10, in the illustrated data applying method, a time period for activating one scan line SL is divided into three periods, and the analog-type R, G and B image data are selected by the switches to be sequentially applied to the unit cells of the liquid crystal cell array during each of the three divided periods.

In the activation of the one scan line SL, the R, G and B image data signals are not applied to the unit cells of the liquid crystal cell array simultaneously. In the data applying method described above, a difference between charging time and discharging time of the liquid crystal capacitor is relatively large. As a result, a display defect such as a vertical stripe may occur on the liquid crystal display panel.

A difference between application times of the analog image signals, and the difference between the charging time and the discharging time of the liquid crystal capacitor are described as follows.

In detail, a time period for activating one scan line (or a time period required that a gate-on signal becomes a high-state) is divided into three periods, and each of R, G and B image data signals is applied to an associated one of first, second and third data lines DL1, DL2 and DL3 during an associated one of the three periods.

During a first time-divided range T1 of the time period for activating the one scan line, the R image signal is applied to a first liquid crystal capacitor C1, charging the first liquid crystal capacitor C1.

During a second time-divided range T2 of the time period for activating the one scan line, the G image signal is applied to a second liquid crystal capacitor C2, charging the second liquid crystal capacitor C2. In addition, the first liquid crystal capacitor C1 at least partially discharges during T2.

During a third time-divided range T3 of the time period for activating the one scan line, the B image signal is applied to a third liquid crystal capacitor C3, charging the third liquid crystal capacitor C3. In addition, the first liquid crystal capacitor C1 and the second liquid crystal capacitor C2 are at least partially discharged during T3.

Therefore, when one scan line SL is activated, each of the R, G and B image data signals is applied to the associated one of the first, second and third liquid crystal capacitors C1, C2 and C3 at the different times from one another. When the number of image frames is increased, a difference in time between the charge and the discharge of each of the liquid crystal capacitors C1, C2 and C3 increases, which may lead to formation of a display defect such as a vertical stripe on the LCD panel.

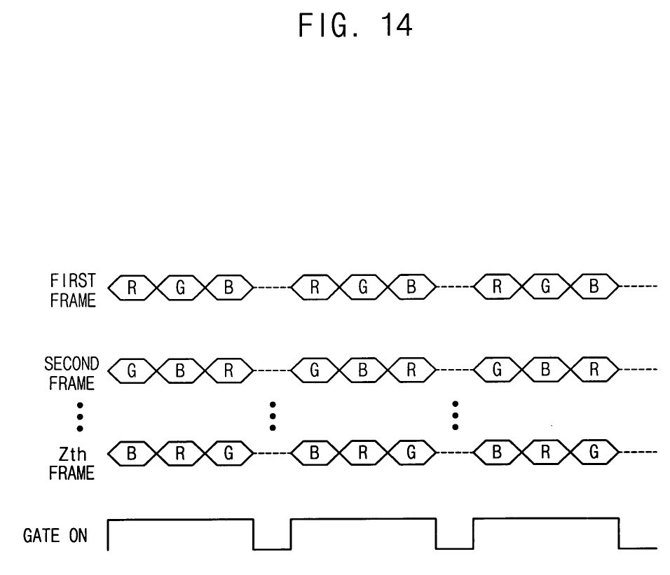

FIGS. 14 through 17 show a data applying method according to an embodiment of the present invention. In particular, FIG. 14 is a timing diagram illustrating a data applying method according to an embodiment of the present invention. FIGS. 15 to 17 are graphs illustrating a charge/discharge amount of a liquid crystal capacitor according to a data applying method shown in FIG. 14.

Referring to FIG. 14, image signals having a sequence of R-G-B are applied to the display cell array such as array 131 of FIG. 7 during a first frame when scan lines SL1, SL2, . . . SLn are activated. In addition, image signals having a sequence of G-B-R are applied to the display cell array 131 during a second frame when scan lines SL1, SL2, . . . SLn are activated. Furthermore, image signals having a sequence of B-R-G are applied to the display cell array 131 during a third frame when scan lines SL1, SL2, . . . SLn are activated.

In order to apply image signals in different sequences to the display cell array 131 during consecutive first to third frames, the application sequence of each of the image signals is altered. One sequence of the image signals is applied to each of the unit cells during each of the first to third frames, with the sequence being altered for consecutive frames. Consequently, while one scan line SL is activated, the time period for charging or discharging the unit cells is an average of a time period for charging the unit cells and a time period for discharging the unit cells.

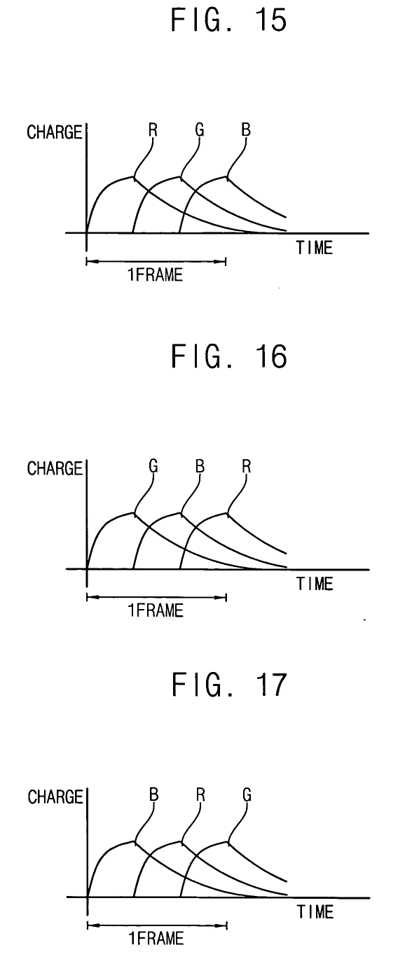

FIG. 15 is a graph showing charging and discharging amount versus time when applying an image signal having a sequence of R-G-B to the display cell array during the first frame. FIG. 16 is a graph showing charging and discharging amount versus time when applying an image signal having a sequence of G-B-R to the display cell array during the second frame. FIG. 17 is a graph showing charging and discharging amount versus time when applying an image signal having a sequence of B-R-G to the display cell array during the third frame.

Referring to FIGS. 15 to 17, when the LCD device is driven according to the driving method shown in FIG. 14, each of the three liquid crystal capacitors C1, C2 and C3 shown in FIG. 11 constituting the unit cell have a substantially identical charge/discharge amount to one another.

Time periods for applying analog-type image signals to unit pixels of color filters and input terminals of the unit cells of the display cell array corresponding to the unit pixels of the color filters are different from one another. The time periods correspond to frames. At the same time, image signals having each of the sequences shown in FIGS. 15 to 17 are applied to the display cell array during each of the frame groups. The number of the frame groups is substantially identical to the divided number of the unit cells (e.g., three).

Referring again to FIG. 8, analog-type image signals having different sequences corresponding to different frame groups are applied to the data lines DL1, DL2, . . . DL3k in response to the first, second and third data select signals S1, S2 and S3. One digital/analog converter may be selectively coupled to one of three associated data lines DL during each of the three-divided periods of a time period for activating one scan line. The selective coupling may be accomplished by controlling each of the data select signals applied to a gate terminal of a MOS transistor.

For example, each of the data lines DL1, DL2 and DL3 may be sequentially coupled to an associated area of the unit cells corresponding to R, G and B u nit pixels of the color filter substrate.

When image signals having sequences of R-G-B, G-B-R and B-R-G are applied to the unit pixels during each of the frames, the timing controller 270 applies data select signals having a sequence of S1-S2-S3 to the signal select unit 252 during the first frame. During the second frame, the timing controller 270 applies data select signals having a sequence of S2-S3-S1 to the signal select unit 252. During the third frame, the timing controller 270 applies data select signals having a sequence of S3-S1-S2 to the signal select unit 252.

By altering the color sequence as described above, an LCD device incorporating fewer DACs may be provided, while display defects such as vertical stripes may be prevented or reduced.

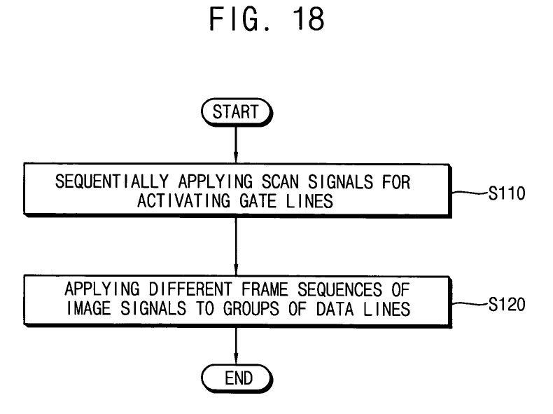

FIG. 18 is a flow chart illustrating a driving method of a display device according to an embodiment of the present invention.

Referring to FIGS. 7 through 9 and FIG. 18, in a driving method of a display device according to an embodiment of the present invention, the display device includes scan lines SL1, SL2, . . . SLn, data lines DL1, DL2, . . . DLm, switching elements ST electrically coupled to the scan lines SL1, SL2, . . . SLn and the data lines DL1, DL2, . . . DLm, and liquid crystal capacitors LC electrically coupled to each of the switching elements ST. The display device sequentially outputs scan signals for activating the scan lines SL1, SL2, . . . SLn (at S110).

At S120, different frame sequences of image signals are applied to groups of data lines. For example, image signals having different sequences from one another are applied to the data lines DL1, DL2, . . . DLm, and are grouped by a predetermined number during each of the frames.

At S110, scan signals for activating scan lines SL1, SL2, . . . SLn are sequentially output. Switching elements electrically coupled to each of the scan lines are then activated, and the image signals may be applied to the liquid crystal capacitors via the data lines DL1, DL2, . . . DLm.

At S120, adjacent data lines of the data lines DL1, DL2, . . . DLm are electrically coupled to a unit cell of the display cell array 131 and are used to apply the R, G and B image data to unit cells of the display cell array 131. For example, the first, second and third data lines DL1, DL2 and DL3 are electrically coupled to one unit cell of the display cell array 131 to apply one of the R, G and B image data to the associated unit cell of the display cell array 131.

In embodiments where the first, second and third data lines DL1, DL2 and DL3 transmit R, G and B image data respectively, a time period for activating the first scan line SL1 is divided into three periods. In order to apply the image signals to the unit cell in a sequence of R-G-B, the data lines transmit the image signals in a transmission sequence of DL1-DL2-DL3 during the first frame. In order to apply the image signals to the unit cell in a sequence of G-B-R, the data lines transmit the image signals in a transmission sequence of DL2-DL3-DL1 during the second frame. In order to apply the image signals to the unit cell in a sequence of B-R-G, the data lines transmit the image signals in a transmission sequence of DL3-DL1-DL2 during the third frame.

As described above, timing controller 270 generates select signals S1, S2, and S3 to control the signal select unit 252, in order to control the sequential data transmission.

The first, second and third data lines DL1, DL2 and DL3 are electrically coupled to associated ones of the MOS transistors Tr1, Tr2 and Tr3 of the signal selector 252, and are electrically coupled to the digital/analog converter DAC1 via the common output line COL1. Accordingly, the digital-type image data corresponding to R, G and B colors are converted into an analog-type image signal by the digital/analog converter DAC1 using a time-division operation.

In alternative embodiments, an image data applying sequence may be altered during each of the predetermined grouped frames instead of altering an image data applying sequence during each of the frames.

According to the embodiments of the present invention described above, the number of the DACs is decreased using the three-division operation by one-third of the number of conventional DACs so that sizes of the drive circuits of the LCD device are decreased, thereby integrating the drive circuits of the LCD device. Reducing the number of DACs also reduces the power consumption of the LCD device.

Furthermore, a display defect such as a vertical stripe effect may be prevented although the display unit cells of the color filter substrate are arranged in the delta shape.

Although the embodiments of the present invention have been described, it is understood that the present invention should not be limited to these embodiments but various changes and modifications can be made by one ordinary skilled in the art within the spirit and scope of the present invention as hereinafter claimed.

What is claimed is:

1. A method of driving a display device having a plurality of scan lines, a plurality of data lines and a plurality of switching elements electrically coupled to the scan lines and the data lines, the method comprising:
sequentially outputting scan signals to the scan lines; and
outputting a first group of N image signals in a first sequence to N grouped data lines of the plurality of data lines, wherein N is a predetermined number; and
subsequently outputting a second group of N image signals in a second different sequence to the N grouped data lines.

2. The method of claim 1, wherein the pre-determined number N of the grouped data lines is three.

3. The method of claim 1, wherein the outputting the first group of image signals in the first sequence and the subsequently outputting the second group of the image signals in a second different sequence is performed during one frame.

4. The method of claim 1, wherein the first group of image signals comprises a first image signal indicative of red image data, a first green image signal indicative of green image data, and a first blue image signal indicative of blue image data.

5. The method of claim 1, wherein a time period for activating each of the scan lines is divided into a plurality of divided time periods, and wherein each of the image signals included in the first group of image signals is applied to an associated one of the pre-determined number of data lines during one of the divided time periods.

6. The method of claim 5, wherein the first group of image signals comprises a first signal indicative of red image data, a first signal indicative of green image data and a first signal indicative of blue image data.

7. The method of claim 6, wherein at least one of the first group of image signals is different than a different one of the first group of image signals.

8. The method of claim 6, wherein the second group of image signals comprises a second signal indicative of red image data, a second signal indicative of green image data, and a second signal indicative of blue image signals, and wherein at least one of the first group of image signals is different than a corresponding one of the second group of image signals.

9. A display device comprising:
a display panel having a plurality of scan lines, a plurality of data lines and a plurality of switching elements electrically coupled to the scan lines and the data lines;
a scan driver configured to sequentially output a plurality of scan signals to the plurality of scan lines; and
a data driver configured to apply a first group of a pre-determined number N of image signals in a first sequence to N grouped data lines of the plurality of data lines, and wherein the data driver is further configured to subsequently apply a second group of N image signals in a second different sequence to the N grouped data lines.

10. The display device of claim 9, wherein the scan driver is formed on the display panel.

11. The display device of claim 9, wherein the data driver comprises:
a digital/analog converter unit configured to convert image data of digital-type into the image signals of analog-type, the digital/analog converter unit further configured to received N digital data signals corresponding to the N image signals and to output the N image signals to the N data lines; and
a signal select unit configured to selectively output the N image signals to the N data lines in a particular sequence.

12. The display device of claim 11, wherein the digital/analog converter unit comprises:
a common input line configured to receive the N digital data signals; and
a common output line configured to output the N image signals.

13. The display device of claim 12, wherein the signal select unit comprises a plurality of switches coupled to the common output line in parallel.

14. The display device of claim 13, wherein the plurality of switches comprises at least one metal oxide semiconductor transistor.

15. The display device of claim 13, wherein the signal select unit is configured to selectively output the N image signals to the N data lines in response to at least one select signal received from an external device.

16. The display device of claim 15, further comprising a timing controller configured to generate the at least one select signal and selectively apply the at least one select signal to the signal select unit.

17. The display device of claim 11, wherein the signal select unit selectively outputs the N image signals to the N data lines in the particular sequence in response to N associated select signals from an external device.

18. The display device of claim 9, wherein each of the switching elements comprises a first electrode electrically coupled to one of the plurality of data lines, a second electrode electrically coupled to one of the plurality of scan lines, and a channel layer formed by an amorphous silicon.

19. A display device, comprising:
a plurality N of digital to analog converters;
a plurality M data signal lines, each of the M data signal lines configured to transmit an analog signal to an associated region of the display to generate an image portion, wherein N is less than M, and wherein each of the N digital to analog converters is in communication with a plurality P of the M data signal lines, wherein P is less than M.

20. The device of claim 19, wherein P is three.

21. The device of claim 19, further comprising an associated signal selector in communication with each of the N digital to analog converters, the associated signal selector for a first digital to analog converter configured to transmit a first sequence of P analog signals generated by the first digital to analog converter to the P associated data lines and to subsequently transmit a second different sequence of P analog signals generated by the first digital to analog converter to the P associated data lines.

22. The device of claim 21, further comprising a timing controller configured to control at least one of the associated signal selectors.

23. The device of claim 21, wherein the first sequence of P analog signals and the second different sequence of P analog signals are transmitted during the same frame.

24. The device of claim 21, wherein the signal selector is configured to generate P different sequences of the P analog signals, the P different sequences including the first sequence and the second sequence.

25. The device of claim 24, wherein the P different sequences are transmitted during P frames of a frame group.

26. The device of claim 19, wherein P is three, and wherein the associated regions of the display are configured in a delta pattern.
